(19) United States
(12) Patent Application Publication
(10) Pub. No.: US 2014/0040585 A1
(43) Pub. Date: Feb. 6, 2014

(54) COMPUTER, MANAGEMENT METHOD, AND RECORDING MEDIUM

(71) Applicants: Yasushi Miyata, Tokyo (JP); Tomoya Ohta, Tokyo (JP); Hiroyasu Nishiyama, Tokyo (JP)

(72) Inventors: Yasushi Miyata, Tokyo (JP); Tomoya Ohta, Tokyo (JP); Hiroyasu Nishiyama, Tokyo (JP)

(73) Assignee: HITACHI, LTD., Tokyo (JP)

(21) Appl. No.: 14/009,225

(22) PCT Filed: Aug. 8, 2012
(86) PCT No.: PCT/JP2012/070144

§ 371 Date: Oct. 11, 2013

(30) Foreign Application Priority Data
Aug. 18, 2011 (JP) 2011-178714

(51) Int. Cl. G06F 3/06

(52) U.S. Cl. CPC G06F 3/0646; G06F 3/0604; G06F 3/0673
USPC 711/165

(57) ABSTRACT

A computer manages memory by dividing the memory into at least a first storage area which stores generated data, and a closable region made of at least one second storage area and at least one third storage area. The second storage area constitutes a destination to which the data stored in the first storage area is to be moved. Data is moved from the first storage area to the second storage area; and the second storage area to which the data has been moved is changed to the third storage area. An update to the data stored in the third storage area is detected and the data of which the update has been detected is moved to a closable region other than the third storage area.

### TECHNICAL FIELD

The present invention relates to a computer, a management method and a program. More particularly, the invention relates to a computer for examining the relations between data, and a non-temporary recording medium for storing a management method and a program for use in such examination.

### BACKGROUND ART

There exist known techniques with which the computer examines the relations between data located in a memory, such as the reference relationship between object data, for example.

Reference relationship examination is needed in the process of collecting the memory areas that store the data having become unnecessary. Specifically, the computer first examines the reference relationship between the data present in the memory areas targeted for collection, and determines the data not referenced by any other data to be garbage data (unnecessary data) while determining the data other than the garbage data to be survived data. The computer then moves the survived data out of the target memory areas to be collected. Thereafter, the computer releases the target memory areas for collection together with the garbage data so that the memory areas may be used again.

For examination of the reference relationship between data, there are techniques used generally to stop business applications or the like on the computer from processing such data. The halt of the processing of data is one method of preventing the reference relationship between data from being changed through data generation or deletion during examination of the references between data. This method is often adopted at the time of examining the reference relationship between data.

This suggests inversely a problem: if an increasing time is spent examining reference relationship, the downtime in data processing can be prolonged and processes can be delayed. There exist diverse known techniques for preventing such process delays.

Non-Patent Literature 1 discloses a technique for reducing data processing downtime by limiting the range of examining references. This technique is used by systems that utilize programs running on languages (e.g., functional programming language) in which no updates occur to the data once generated except its deletion. First, in the order in which data has been generated, the memory area is divided into an area that stores old-generation data and an area that stores new-generation data. And the process of collecting unnecessary regions from the area that stores new-generation data is performed preferentially so as to reduce the number of times the process of collecting garbage data is carried out until a predetermined area is collected. As a result, this technique provides the effect of shortening the downtime of processing such as plications.

The technique above gives priority to the area that stores new-generation data because the systems to which it is applied are assumed to perform specialized data processing. That is, this technique is assumed to be applied to the systems performing data processing such that newly generated data is likely to become unnecessary while old data generated a long time ago tends to remain unchanged.

That is because the functional programming language keeps its data intact so that there can be no reference to the data belonging to the new generation that did not exist when the data belonging to the old generation was generated. It follows that, in order to acquire all data serving as the sources for references to the data belonging to the new generation, the new-generation data need only be examined while the generation of new-generation data is temporarily halted.

Also, Non-Patent Literature 2 discloses a data management technique for dividing old-generation data into further generations. The division in this context means to divide the memory area into a plurality of areas of a constant amount each. Upon processing of the collection of the memory area that stores garbage data, only one divided area is subjected to the examination of reference sources. This reduces the amount of the data targeted for the examination of reference sources, compared with all old-generation areas being targeted for collection processing. As a result, this technique provides the effect of shortening the downtime of data processing in the process of collecting the garbage data area in a single pass.

### CITATION LIST

### Non-Patent Literature

Non-Patent Literature 1: Todd A. Anderson, Optimizations in a Private Nursery-based Garbage Collector, In Proceedings of the 2010 international symposium on Memory management, pp. 21-30, 2010
Non-Patent Literature 2: Richard L. Hudson, Incremental collection of mature objects, In Proceedings of the International Workshop on Memory Management, pp. 388-403, 1992

### SUMMARY OF THE INVENTION

### Technical Problem

However, since the technique of Non-Patent Literature 1 presupposes the use of the above-mentioned functional programming language, it can be applied only in a specific environment where there occurs no event involving old-generation data referencing new-generation data that did not exist when the old-generation data was generated. The technique cannot be applied to the systems that use languages in which updates other than deletion occur to data (deletion of data in this context means that the data in question is put in a state that cannot be referenced by specific data; such deletion does not add new reference sources to the new-generation or old-generation data) and in which there are generated events involving old-generation data referencing new-generation data regardless of the time of data generation. In the system using such a language in which references are made from old-generation data to new-generation data, examining the reference sources for the data belonging to the old generation requires targeting all areas covering the new generation and old generation. The range of examining references cannot be limited to the data belonging to the new-generation.

Meanwhile, as disclosed in Non-Patent Literature 2, if the memory area that stores the old-generation data is divided generationally into a first generation, a second generation, . . . , and an Nth generation in chronological order in which the data was generated, the reference sources for the Nth generation data can be limited to the data belonging to the Nth and the subsequent generations. Thus the range of reference examination may be said to be limited.

However, even with the technique of Non-Patent Literature 2, if updates occur to data of a generation preceding the Nth generation, the target for examining reference relationship is not perfect; there remains the problem of survived data being deleted unintentionally (during the process of releasing the memory). That is, it may not be appropriate to apply this technique to languages in which updates can occur to the data once generated.

The primary object of the present invention is to perform efficiently the examination of relations such as reference relationship between data or the like in a language or on a system where data updates occur, whereby computer performance is enhanced.

### Solution to Problems

In achieving the above object of the present invention and according to one aspect thereof, there is provided a computer having an arithmetic unit and a memory for carrying out a predetermined business application, the computer including: memory management means for managing the memory while dividing the memory into at least a first storage area which stores generated data, and a closable region made of at least one second storage area and at least one third storage area, the second storage area constituting a destination to which the data stored in the first storage area is moved, the third storage area not constituting a destination to which the data stored in the first storage area and the second storage area is to be moved; data movement means for moving data having relations to the data in the first storage area to the second storage area; area change means for changing the second storage area to which the data has been moved to the third storage area; update detection means for detecting any update to the data stored in the third storage area; updated data movement means for moving the data of which the update has been detected to the closable region other than the third area; and examination means for examining relations in the memory between the data in the closable region to which the data has been moved and the data stored in the first storage area.

### Effects of Invention

According to the present invention, it is possible to perform efficiently the examination of relations such as the examination of references necessary for diverse kinds of data management in a language in which data updates occur, whereby computer performance is enhanced. Further objects, structures and advantages of the present invention will become apparent upon a reading of the explanation that follows.

### BRIEF DESCRIPTION OF THE DRAWINGS

FIG. 1 is a block diagram showing a structure of a computer as a first embodiment.

FIG. 2 is a block diagram showing a functional structure of the computer as the first embodiment.

FIG. 3 is a schematic view showing a closable region management table for the computer as the first embodiment.

FIG. 4 is a flowchart showing the flow of a data registration process performed by the computer as the first embodiment.

FIG. 5 is a flowchart showing the flow of a closing region management process performed by the computer as the first embodiment.

FIG. 6 is a flowchart showing the flow of a closure determination process performed by the computer as the first embodiment.

FIG. 7 is a flowchart showing the flow of a data update process indicative of a processing flow on the computer as the first embodiment.

FIG. 8 is a transition diagram schematically representing states of data movements and the like on the computer as the first embodiment.

FIG. 9 is a transition diagram schematically representing other states of data movements and the like on the computer as the first embodiment.

FIG. 10 is a block diagram showing functional structures of a computer as a second embodiment.

FIG. 11 is a schematic view showing a closable region management table for the computer as the second embodiment.

FIG. 12 is a flowchart showing the flow of a data change storage process performed by the computer as the second embodiment.

FIG. 13 is a flowchart showing the flow of a closed region release process performed by the second embodiment.

FIG. 14 is a transition chart schematically representing states of data movements and the like in the closed region release process performed by the second embodiment.

FIG. 15 is a block diagram showing a functional structure of a computer as a third embodiment.

FIG. 16 is a flowchart showing the flow of a preliminary process and a region release process performed by the computer as the third embodiment.

FIG. 17 is a flowchart showing the flow of a referenced data movement process performed by a computer as a fourth embodiment.

FIG. 18 is a block diagram showing a structure of a computer as a fifth embodiment.

FIG. 19 is a schematic view showing a typical screen displayed on a service level management device of the computer as the fifth embodiment.

FIG. 20 is a flowchart showing a processing flow on the service level management device of the computer as the fifth embodiment.

### DESCRIPTION OF EMBODIMENTS

Embodiments of the present invention are explained below in reference to the accompanying drawings.

### First Embodiment

As the first embodiment, a typical computer device is explained that limits the range of examining references on a system running on a program prepared in a language in which data changes occur.

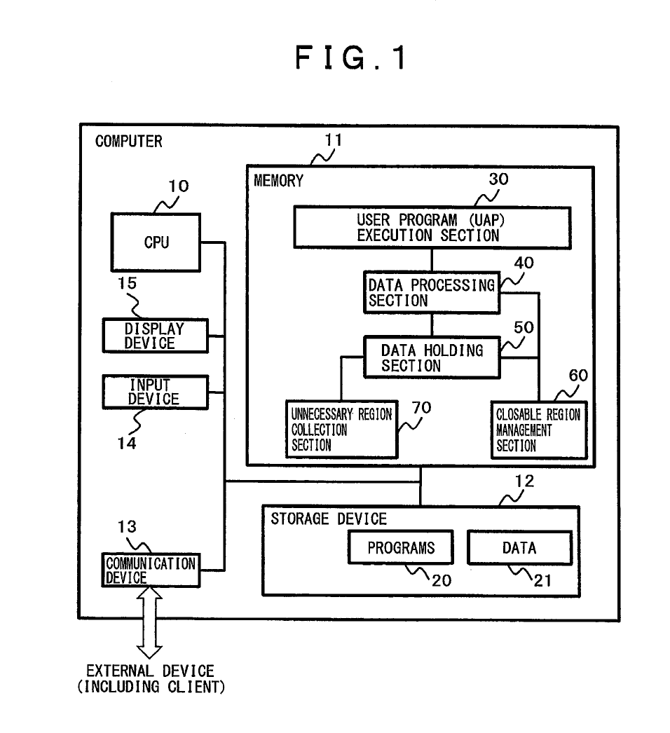

FIG. 1 shows a structure of a computer as the first embodiment to which this invention is applied. The computer can be implemented using a general-purpose computer that includes a CPU 10, a memory 11, a storage device 12 such as a hard disk, a communication device 13, an input device 14, and a display device 15. The CPU 10 implements various functional sections that read various programs 121 and data 122 stored in the storage device 12 into the memory 11 to carry out diverse processes through coordination between the retrieved programs and data. The memory 11 has the retrieved programs 20 deployed therein and, in coordination between the programs 20 and the CPU 10, implements various functional sections including a user program execution section (called the UAP execution section hereunder) 30, a data processing section 40, a data holding section 50, a closable region management section 60, and an unnecessary region collection section 70. The storage device 12 functions as an auxiliary storage device that stores the programs 20 and data 21 with which the computer 1 performs its processing. The input device 14 is a keyboard, a mouse, etc., operated by a user to input various instructions for program startup, data management, etc., into the computer 1. The display device 15 is a display or like equipment that displays status and results of process execution by the computer 1, among others. The communication device 13 is an interface that communicates various data and commands with an external computer device or the like (not shown) by way of a wired or a wireless communication network such as a LAN, a WAN, the Internet, etc.

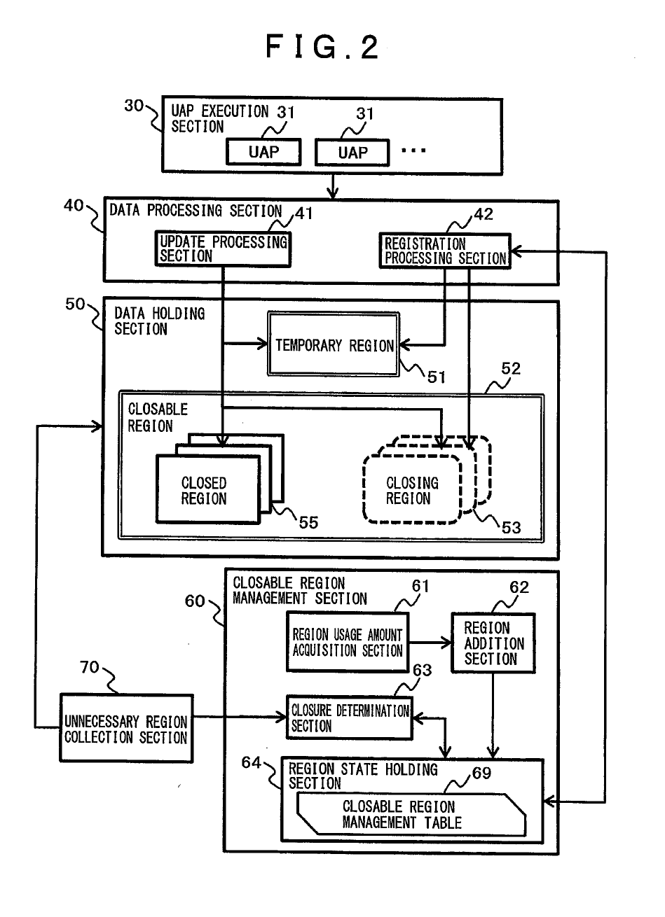

FIG. 2 shows detailed structures of various functional sections configured in the memory 11. The UAP execution section 30 is a functional section that executes at least one UAP 31 for implementing data processing such as data generation, updating, and deletion. Each UAP 31 performs data processing on the data held in a temporary region 51 of the data holding section 50. Also, in order to move data from the temporary region 51 to a closable region 52 for use in subsequent processing by the UAP in question or by another UAP 31, each UAP 31 requests a registration processing section 42 of the data processing section 40 to register the corresponding data. Although this embodiment is explained using an example in which the UAP 31 requests the registration processing section 42 to perform registration, it can also be arranged that the registration processing section 42 selectively registers data that has not become unnecessary.

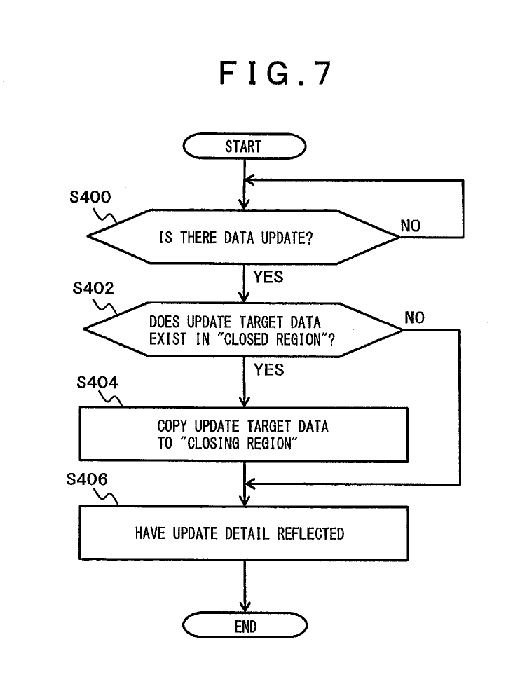

The data processing section 40 has an update processing section 41 and the registration processing section 42. The registration processing section 42 is a functional section that registers the data transmitted from the UAP 31 while causing the data holding section 50 to hold the transmitted data at the same time so that registered data can be reused by the UAP 31 in question or by some other UAP 31. The update processing section 41 is a functional section that updates data held in the data holding section 50 and moves data within the data holding section 50 in a “data update process (FIG. 7),” to be discussed later. Although this embodiment is explained using an example in which data movements are carried out through copying, it is also possible to delete the data at a movement source after such copying.

The detection of a data update is accomplished by the update processing section 41 supplying the UAP 31 with a proxy object for detecting the update process. The proxy object references the data targeted for processing by the UAP 31 and receives various processes from the UAP 31 onto the data held in the data holding section 50. Upon receipt of an update process request from the UAP 31, the proxy object notifies the update processing section 41 of the data update. In addition to this kind of update detection, various arrangements may be utilized for such detection. For example, the closable region management section 60, to be discussed later, may inhibit write operations on the memory area to which the closable region is allocated and, with an exception arranged to be generated upon occurrence of a write operation, acquire the exception to detect the update.

The process of copying data is performed as follows: If a data update process is received by the proxy object and if the data targeted for update is held in a closed region 55 (and if that closed region 55 is targeted for release), the update processing section 41 copies the update target data into a closing region (waiting-to-be-closed region) 53. Thereafter, the detailed update is reflected in the copied data.

The data holding section 50 is a functional section that provides a data storage area divided into the temporary region 51 and closable region 52 for storing data therein. The temporary region 51 is a storage area that stores temporarily the data for use by the UAP 31. With this embodiment, the data transmitted from the UAP execution section 30 via the data processing section 40 is always held first in the temporary region 51. The closable region 52 is a movement destination storage area to which the data held in the temporary region 51 is moved upon some suitable occasion. Incidentally, the closable region 52 is an aggregate of divided areas each holding a desired amount of data and constituting the data holding area. Each divided closable region can hold a finite amount of data.

The divided closable regions making up the closable region 52 are further divided into closing regions 53 and closed regions 55 for management by the data holding section 50. The closing regions 53 serve as the destinations to which the data registered by the registration processing section 42 may be moved from the temporary region 51, and constitute storage areas into which new data may be additionally stored or in which existing data may be overwritten with updated data. The closed regions 55 do not serve as the destinations to which the data held in the temporary region 51 or in any closing region 53 may be moved, and constitute a storage area into which new data cannot be additionally stored or in which existing data cannot be overwritten. When the amount of data held in a closing region 53 reaches a predetermined level, that closing region 53 starts to be managed as a closed region 55.

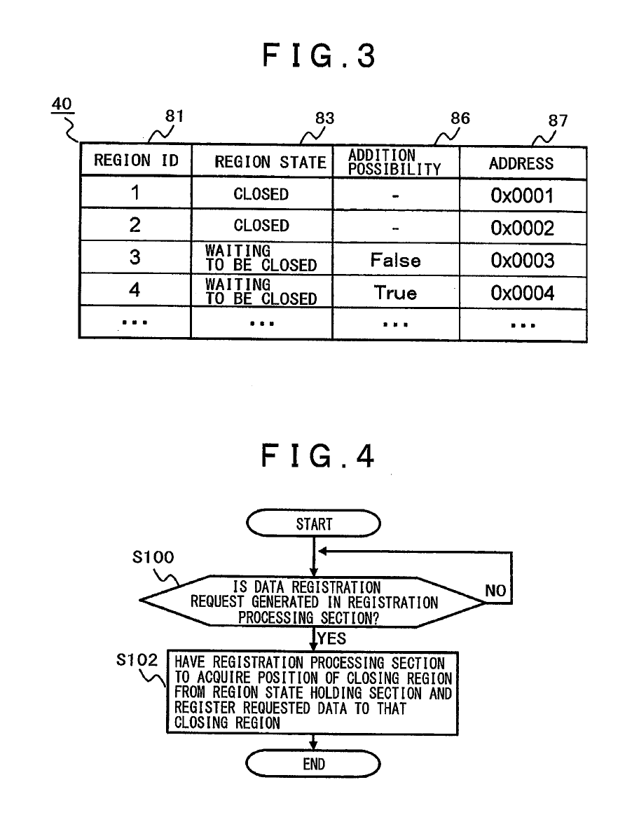

The closable region management section 60 is a functional section that manages the closing regions 53 and closed regions 55 and includes a region usage amount acquisition section 61, a region addition section 62, a closure determination section 63, and a region state holding section 64. The region usage amount acquisition section 61 is a functional section that acquires the memory usage amount of the closing regions 53. The region addition section 62 is a functional section that adds a closing region 53 anew to the closable region 52. The closure determination section 63 is a functional section that determines whether the usage amount of a closing region 53 is larger than a predetermined threshold value. The closing region 53 of which the usage amount is determined by the closure determination section 63 to be larger than the threshold value is managed thereafter as a closed region 55. The area state holding section 64 is a functional section that associates the result of determination by the closure determination section 63 with the ID or the like of each divided closable region for storage in a closable region management table 69 (see FIG. 3), to be discussed later.

The unnecessary region collection section 70 is a functional section that examines the reference relationship between the data held in the data holding section 50 and releases (collects) the region determined through the examination to be a region that holds garbage data. More specifically, through the examination of reference relationship, the unnecessary region collection section 70 determines the data referenced from some other data to be survived data and the data not referenced from any other data to be garbage data. The unnecessary region collection section 70 moves the survived data to a region which is not the release target region and in which the reference source of the survived data in question is stored, and performs a GC (garbage collection) process to release (collect) the region that holds the garbage data. That is, the survived data found in the temporary region 51 is moved to a closing region 53, and part or all of the temporary region 51 is released (collected).

FIG. 3 schematically shows a closable region management table 69. The closable region management table 69 associates such information as region IDs 81, region status 83, and addition possibility 85 with one another for management purposes. The region IDs identify the closing regions 53 and closed region 55 allocated to the closable region 52. The region status 83 indicates whether each of the divided regions allocated to the closable region 52 is closed or waiting to be closed. The addition possibility 85 is information indicating whether the usage amount of each closing region 53 exceeds a predetermined threshold value. “False” in the addition possibility 85 means that the usage amount exceeds the predetermined threshold value and that storage of any more data is inhibited; “True” means that the usage amount is below the predetermined threshold value and that storage of more data is possible.

Whereas this embodiment is explained using an example in which the information about management of the closable region is managed in the form of the closable region management table 69, lists or some other suitable means may be used alternatively in place of the table.

The processing flow of each of the functional sections is explained next using the accompanying flowcharts.

FIG. 4 shows the flow of a “data registration process” performed by the registration processing section 42.

The registration process in this context is a process in which the UAP 31 executed by the UAP execution section 30 registers the data generated during its execution process to the temporary region 51 included in the data holding section 50 via the registration processing section 42, using the instructions written in the UAP 31 or the instructions supplied via the input device 14 or communication device 13.

In S100, the registration processing section 42 waits until a data registration request is generated. Upon detecting generation of a data registration request (S100: Yes), the registration processing section 42 acquires position information (address 87) about a closing region 53 from the region state holding section 64 in S102, and registers the requested data to the closing region 53 about which the position information has been acquired. The registration in this context is the process of associating the closing region 53 corresponding to the position information with the target data to be registered. For example, a reference to the registration target data may be written to existing data in the closing region 53. As another example, an ID may be assigned to the registration target data and the ID in question may be written to the table in which the ID is associated with the corresponding closing region 53.

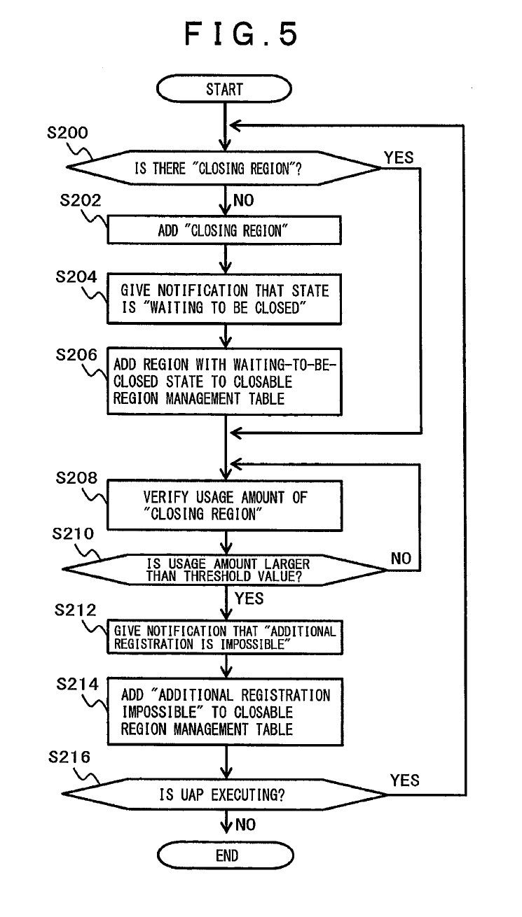

FIG. 5 shows the flow of a “closing region management process” performed by the closable region management section 60.

First in S200, typically upon occasion of execution of the UAP 31, the region addition section 62 determines whether there exists any closing region 53 in the data holding section 50. If there is no closing region 53 (S200: No), the region addition section 62 performs the process of adding a closing region 53 (S202). If there is a closing region 53 (S200: Yes), the region addition section 62 reaches S208 and transfers processing to the region usage amount acquisition section 61.

In S204, the region addition section 62 notifies the region state holding section 64 of information indicating that the added region is a closing region.

In S206, the region state holding section 64 having received the notification registers the ID indicative of the added closing region 53 to the region ID 81 while registering the status of the closing region 53 to the region status 83 at the same time so that the information may be managed in association with one another in the closable region management table 69. Thereafter, the region state holding section 64 transfers processing to the region usage amount acquisition section 61.

In S208, the region usage amount acquisition section 61 acquires the data usage amount of the added closing region 53 either periodically or on a suitable occasion, and notifies the region addition section 62 of the acquired amount. Incidentally, the data usage amount acquired by the region usage amount acquisition section 61 may be a data count or a data size.

In S210, the region addition section 62 determines whether the acquired usage amount exceeds a predetermined threshold value. If the acquired usage amount is smaller than the threshold value (S210: No), the region addition section 62 waits for a predetermined time period before returning processing to S208. On the other hand, if the usage amount is larger than the predetermined threshold value (S210: Yes), the region addition section 62 in S212 notifies the region state holding section 64 of information indicating that registration of addition data to the closing region 53 is impossible.

In S214, the region state holding section 64 registers the information indicating that additional registration is impossible to the addition possibility 85 so that the information may be managed in association with the region ID 81 in the closable region management table 69. For example, the addition possibility 85 may be expressed as “True” if the addition is possible and as “False” if the addition is impossible.

It should be noted that the addition possibility 85 is not necessary if it is definitively confirmed that no data movement will occur from now on. In that case, the status of a closing region 53 may be changed to that of a closed region 55 in substitution for the addition possibility 85.

In S216, the region addition section 62 determines whether the UAP 31 is currently executing. If the UAP 31 is currently executing (S216: Yes), the region addition section 62 returns to S200; if the UAP 31 is not currently executing (S216: No), the region addition section 62 terminates the process.

Meanwhile, the above-described “closing region management process” may generate a closing region 53 to which additional data cannot be registered. In this case, the closure determination section 63 performs a “closure determination process” on the closing region 53 to which the additional registration of data is impossible. The “closure determination process” is a process in which, if there is no data reference to the data in the temporary region 51 from the data held in the closing region 53, the closing region 53 to which additional data cannot be registered is changed to a closed region 55. The timing of executing the closure determination process is when the unnecessary region collection section 70 performs the GC process. More specifically, the timing is immediately after a movement of survived data has occurred in the GC process.

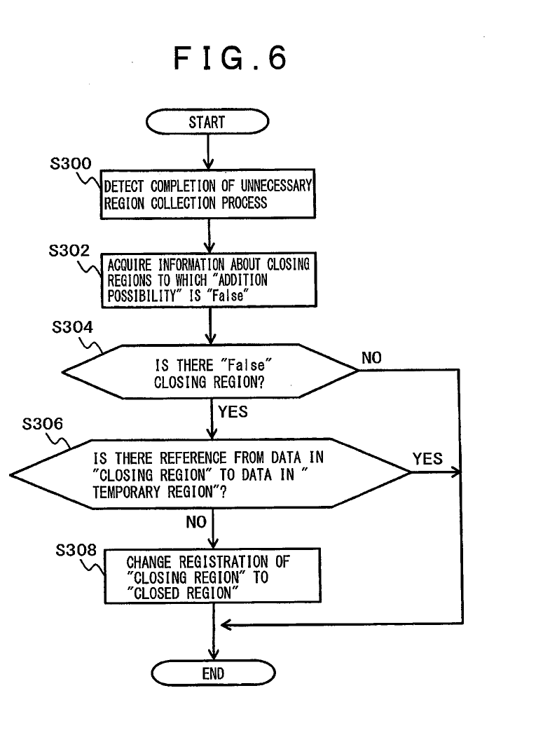

FIG. 6 shows the flow of a “closure determination process.”

In S300, after the unnecessary region collection section 70 has started the GC process taking the temporary region 51 and closing regions 53 as the target for reference source examination, the closure determination section 63 detects completion of a movement of survived data to the temporary region 51.

In S302, the closure determination section 63 acquires information about the closing regions 53 to which the additional registration of data from the region state holding section 64 is impossible (False).

In S304, the closure determination section 63 determines whether there exists a “False” closing region 53. If there is one (S3004: Yes), the closure determination section 63 goes to S306; if there is no such region (S304: No), the closure determination section 63 terminates the process.

In S306, the closure determination section 63 verifies whether there is any reference to the data in the temporary region 51 from the data that exists in the “False” closing region 53. This verification of reference may utilize the result of the reference examination in the immediately preceding GC process.

In S308, the closure determination section 63 determines whether there exists any reference to the data in the temporary region 51 from the data in the closing region 53. If there is no such reference (S306: No), the closure determination section 63 transmits to the region state holding section 64 an instruction to change the closing region 53 in question to a closed region 52, and registers the region status 83 to “Closed” in the closable region management table 69. If there is any reference from the data in the closing region 53 to the data in the temporary region 51 (S306: Yes), the closure determination section 63 terminates the process.

If there occurs no update to the data present in the closed regions through the above processing, it can be guaranteed that there is no reference from the closed regions 55 to the temporary region 51.

There follows an explanation of a “data update process” carried out when an update occurs to the data present in a closed region 55. This process fully guarantees that there is no reference from the closed regions 55 to the temporary region 51.

FIG. 7 shows the flow of the “data update process” performed by the update processing section 41.

In S400, the update processing section 41 waits until a data update process performed by the UAP 31 is detected. The detection of the update is accomplished when the proxy object provided by the update processing section 41 to the UAP 31 notifies the update processing section 41 of the update. Upon detection of the update (S400: Yes), the update processing section 41 goes to S402.

In S402, the update processing section 41 verifies whether there exists the data targeted for the update in the closed regions 55. If there exists such data in a closed region (S402: Yes), the update processing section 41 goes to the process of S404. If there exists the update target data outside the closed regions 55 (S402: No), the update processing section 41 goes to the process of S406.

In S404, the update processing section 41 copies to a closing region 53 the update target data present in the closed region 55, and sets the copy destination as the destination where the update is reflected.

In S406, the update processing section causes the update detail to be reflected in the reflection destination.

In the process of S402 for verifying the destination region into which to store the update target data, the proxy object may be caused to make the verification. For example, the verification can be accomplished, for example, when the proxy object is provided with a field value for determining whether the region exists among the closed regions 55. If the proxy object is not used, the reference destination referenced by the data referring to the update target data is updated to the data of the update destination.

Where the proxy object is used, it is possible for the data that references the update target data to detect a data copy destination through the proxy object. If the proxy object is not used, it is impossible for the data that references the update target data to detect the data copy destination. Thus in order to update the reference destination for the data referring to the update target data to the data of the copy destination, the copy source data may be provided with a field value and copy destination information for determining whether an update has been made, for example. This allows the data having a reference to the copied data to determine on a suitable occasion whether the update has been made. If it is determined that the update has been made, the reference destination can be updated to the copy destination by use of the copy destination information. Alternatively, the update processing section may hold copy source information and copy destination information so as to let the reference destination of given data be updated from the copy source to the copy destination.

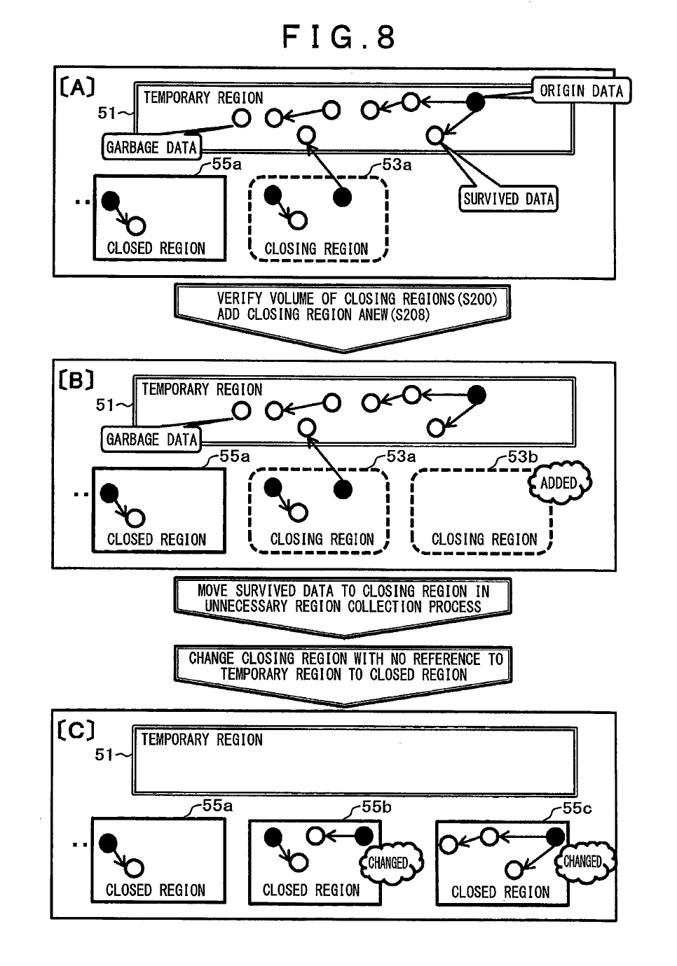

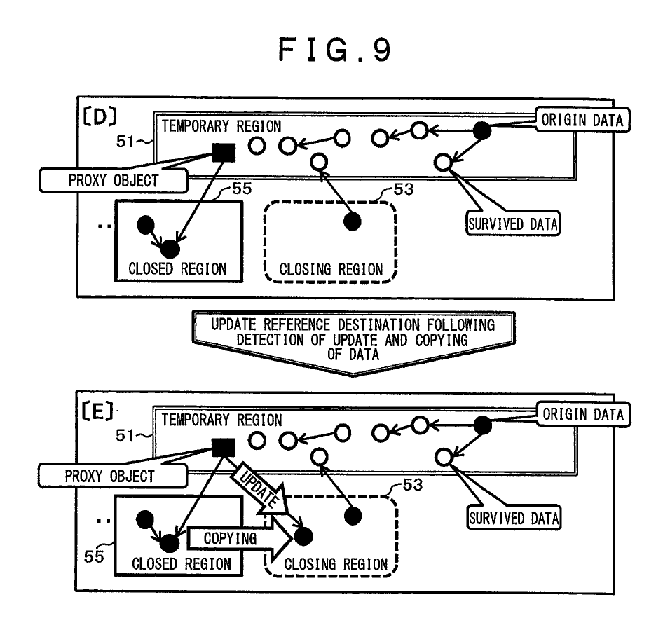

As the end of the explanation of the first embodiment, data transitions taking place primarily in the data holding section 50 during the “closing region management process” shown in FIG. 5, during the “closure determination process” in FIG. 6 and during the “data update process” in FIG. 7 are explained below using the schematic views of FIGS. 8 and 9. In FIGS. 8 and 9, hollow circles denote data, and filled circles specifically represent reference origin data. Arrows connecting the data stand for data references. The data referenced by arrows from other data and the data from which references originate signify survived data; the other data with no references signify garbage data.

First, the data transitions in the “closing region management process” of FIG. 5 and in the “closure determination process” in FIG. 6 are explained using FIG. 8. It is assumed that the relations between data and regions are initially those in the state [A] of FIG. 8. First, the closable region management section 60 verifies the closing regions 53 and their usage amounts or the like (S200, S208). If a lack of space is detected, the closable region management section 60 adds a new closing region 53 (S202) as shown in the state [B] of FIG. 8.

Thereafter, the unnecessary region collection section 70 performs the GC process on a suitable occasion. The GC process involves moving survived data to a closing region 53. At this point, the data referenced from the data in a closing region 53 is moved to the same closing region 53 as that of the reference source; the other survived data is moved to a closing region 53 together with the origin data. Later, as shown in the state [C] of FIG. 8, the closing region 53 to which the addition of data is impossible and which has no reference to the temporary region 51 is changed to a closed region 55 (S308).

The “data update process” in FIG. 7 is explained next using FIG. 9. In FIG. 9, filled rectangles denote a proxy object each.

In the data update process, the update processing section 41 detects data updates using proxy objects. Upon detecting an update, the update processing section 41 copies the update target data to a closing region 53 and then causes the update that changes the reference destination to be reflected.

The above-explained processing limits the regions where changes occur in reference relationship in a language where data changes occur, to the temporary region 51 and closing regions 53. The limitation makes it possible to limit the target data for reference examination for which the UAP 31 needs to be stopped, to the data held in the temporary region 51 and closing regions 53.

The first embodiment has been explained above. According to the computer 1 of this embodiment, it is possible to limit the range of examining reference relationship in the GC process or the like. This reduces the time and the load involved in the process of examining reference relationship, whereby the processing downtime of the UAP 31 is shorted and the performance of the computer 1 is expected to be improved.

In particular, when an update occurs to data held in a closed region 55, the computer 1 reflects the update by preparing a copy of the data of interest in a closing region 53. Thus, even if the closed regions 55 are excluded from the range of reference process examination, the examination will not miss any updated data. This helps maintain the accuracy in examining reference relationship.

### Second Embodiment

The second embodiment is characterized in that it releases the closed regions in which the number and the volume of the data having become unnecessary are large. If the closed regions where the number and the volume of the data having become unnecessary are significant are released, more memory areas than ever can be reused. Generally, data may be said to become unnecessary when its reference source no longer exists as a result of an update or deletion of the data in question.

With the computer of the above-described first embodiment, when an update occurs to data held inn a closed region, the update target data is arranged to be copied to a closing region to reflect the update. Thus the copy source data targeted for the update is predicted to become unnecessary. Also, when data is deleted, any reference from specific data becomes nonexistent and thus the data in question is predicted to become unnecessary.

Meanwhile, data can be referenced from a plurality of data. Thus, just because data is updated or deleted with the first embodiment, it does not mean the data immediately becomes unnecessary. That is, to verify that updated or deleted data has become unnecessary requires examining whether there is no source of reference to the data of interest in all closed regions. This examination of reference sources requires halting the UAP, so that data processing can be delayed.

Thus with the second embodiment, an example is explained of a computer that stores as a data change count the changes in data status such as updates and deletion in the divided closable regions for use in selecting a release target region. This makes it possible efficiently to select as the release target the closed regions predicted to contain numerous data areas available for reuse (i.e., closed regions predicted to have numerous garbage data).

In reference to the accompanying drawings, the computer of the second embodiment is explained below. In the ensuing explanation, the components having the same functions as those of the computer of the first embodiment are given the same reference numerals, and their detailed explanations are omitted hereunder.

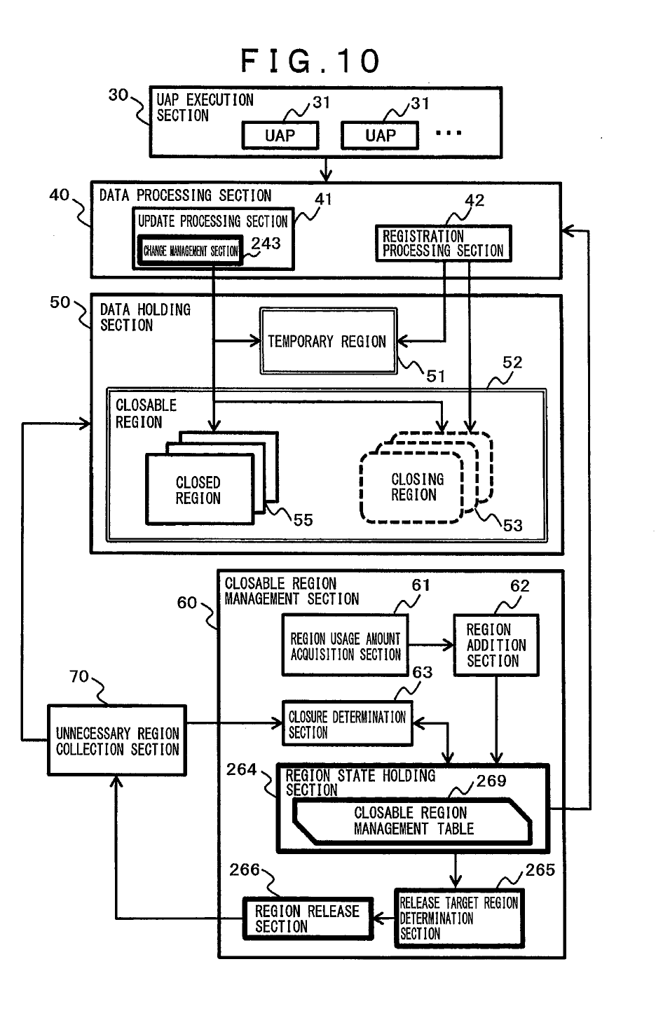

FIG. 10 shows structures of the functional sections configured in the memory 11 of the computer as the second embodiment. The computer 200 of the second embodiment has a closable region management section 60 that further includes a release target region determination section 265 and a region release section 266. A region state holding section 264 and a closable region management table 269 in the closable region management section 60 are provided with functional structures further improving on the region state holding section 64 and closable region management table 69 in the first embodiment. Also, the update processing section 41 in the data processing section 40 further includes a change management section 243. These are the major points that differ from the computer 1 of the first embodiment.

The release target region determination section 265 is a functional section that determines whether or not a given closed region 55 is to be the release target. More specifically, based on data change counts 289 (to be discussed later) registered in the closable region management table 269, the release target region determination section 265 performs a “release target region determination process” to determine that closed regions 55 having numerous changed data in their stored data are to be the release target regions.

The region release section 266 is a functional section that examines references from another closable region (including other closed regions 55, closing regions 53, and a temporary region 51) that regards as the reference destination the data held in the closed regions 55 determined by the release target region determination section 265 to be the release target, and moves referenced data (reference destination data) held in the closed regions 55 to the closable region that contains the referencing data (reference source data). Thereafter, this functional section releases (collects) the memory allocations of the closed regions 55 constituting the release target.

The change management section 243 is a functional section that performs a “data change storage process” to detect updates to and deletion of data before registering the number of such changes to the closable region management table 269. With this embodiment, the proxy object explained in examples for the first embodiment is caused to function as the change management section 243. Upon detecting an update to or deletion of data, the change management section 243 identifies the closable region (closing regions 53 and closed regions 55) to which the target data belongs and notifies the region state holding section 264 thereof. The region state holding section 264 is then caused to register the total number of changes in that closable region to the closable region management table 269.

The region state holding section 264 also has the function of registering to the closable region management table 269 the number of updates to and deletion of data notified by the change management section 243 upon detection thereof, with regard to each closed region 55 that contains the updated or detected data.

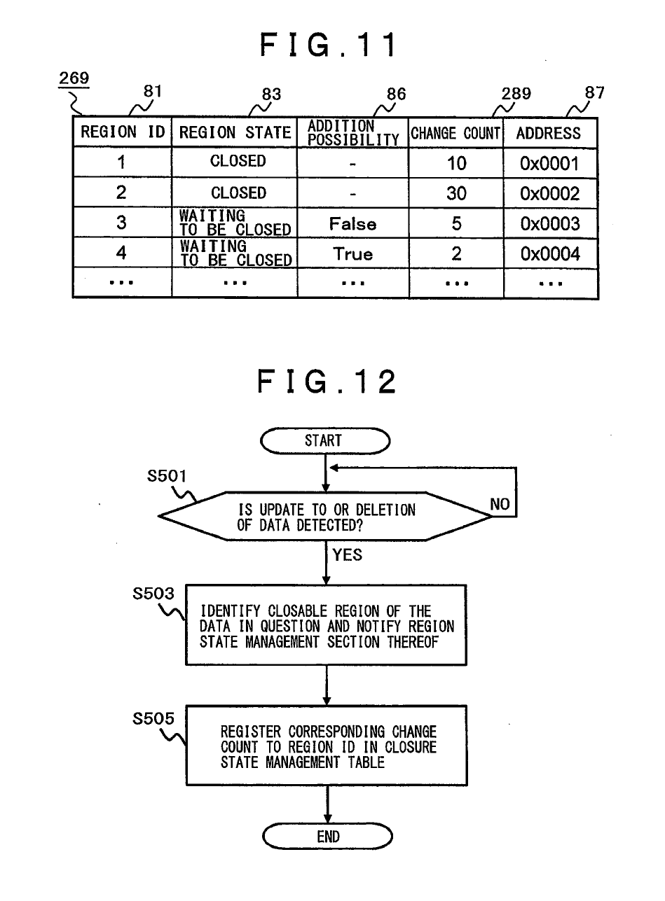

FIG. 11 schematically shows the closable region management table 269. As shown in FIG. 11, the closable region management table 269 further includes the items of data change counts 289.

In describing the second embodiment configured as explained above, FIG. 12 shows the flow of a “data change storage process.”

In S501, the change management section 243 waits for an update to or deletion of data to be detected.

In S503, upon detection of an update to or deletion of data (S501: Yes), the change management section 243 identifies the closed region (53 or 55) that stores the data targeted for an update or deletion, and notifies the region state holding section 264 thereof.

In S505, the region state holding section 264 registers the number of changes in the closable region of interest to the data change count 289 corresponding to the relevant region ID 81 in the closable region management table 269.

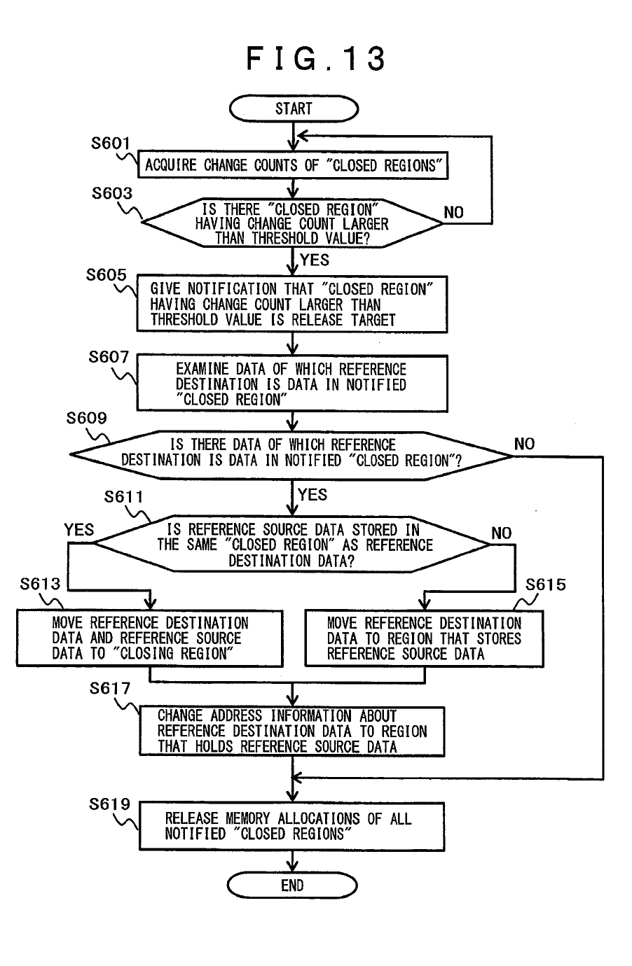

FIG. 13 shows the flow of a “closed region release process” performed by use of the change counts registered in the “data change storage process.”

In S601, the release target region determination section 265 references the closure state management table 269 periodically or on a suitable occasion to acquire the number of changes in the regions of which the region status 83 is “closed” (i.e., closed regions 55).

In S603, it is determined whether there exists any closed region 55 in which the acquired number of changes is larger than a predetermined threshold value. If all closed regions 55 are determined to have fewer changes than the threshold value (S603: No), step S601 is reached again. On the other hand, if it is determined that there exists a closed region having the number of changes larger than the predetermined threshold value (S603: Yes), the release target region determination section 265 goes to step S605.

In S605, the release target region determination section 265 notifies the region release section 266 of the closed region 55 of which the change count is larger than the threshold value as a release target region.

In S607, the region release section 266 examines the data having references to the data stored in the closed region 55 notified as the release target region (i.e., examines the referencing data of which the reference destination is the data held in the closed region 55). The range of this examination covers all data regions including the temporary region 51 and closable region 52.

In S609, based on the result of the examination, the region release section 266 determines whether there exists any referencing data of which the reference destination is the data stored in the closed region 55 targeted for release. If it is determined that such referencing data exists (S609: Yes), the region release section 266 goes to step S611. On the other hand, if it is determined that there is no such referencing data (S609: No), the region release section 266 goes to step S619.

In S611, the region release section 266 determines whether the referencing data determined to exist in S609 is stored in the same closed region 55 as the referenced data. If it is determined that the referencing data and the referenced data are stored in the same closed region 55 (S611: Yes), the region release section 266 goes to step S613. On the other hand, if it is determined that the referencing data and the referenced data are not stored in the same closed region 55 (S611: No), the region release section 266 goes to step S615.

In S613, the region release section 266 moves (or copies) the referencing data and the referenced data stored in the same closed region 55 to a closing region 53.

In S615, on the other hand, the region release section 266 moves (or copies) the referenced data stored in the closed region 55 to the region that stores the referencing data (i.e., temporary region 51 or closing region 53).

In S617, the region release section 266 changes the address (pointer) information for the referencing data to reference the referenced data, to the address information about the region in which the referencing data is present.

The region release section 266 releases the memory allocations of all closed regions 55 notified in S605 by the release target region determination section 265 as the release target, thereby collecting the memory area.

What has been discussed above are the “data change storage process” and “closed region release process” as one major feature of the second embodiment.

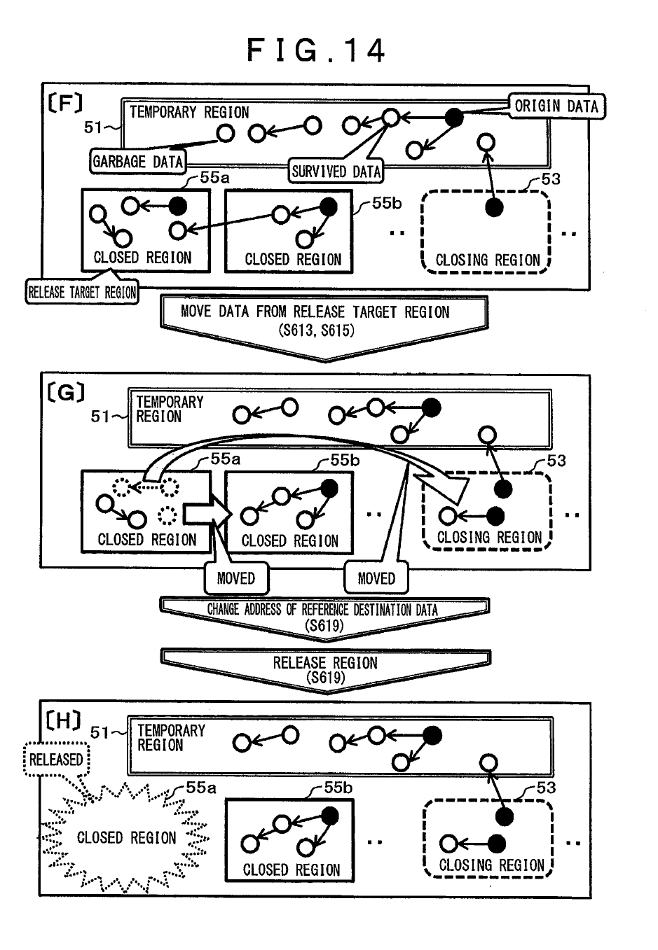

At the end of the explanation of the computer of the second embodiment, data transitions taking place primarily in the data holding section 50 during the “data change storage process” shown in FIG. 12 and during the “closed region release process” in FIG. 13 are explained below using the schematic view of FIG. 14.

In FIG. 14, hollow circles denote data, and filled circles represent origin data. The data referenced by arrows from the origin data is survived data, and the data not thus referenced is garbage data. It is assumed that the relations between data and regions are initially those in the state [F] of FIG. 14.

In the state [F], the data stored in a release target region 55a includes the referencing data and referenced data present in the same region as well as the referenced data (survived data) referenced from the referencing data (origin data) stored in a closed region 55b that is another region.

First, in S613 or S615, the region release section 266 moves to a closing region 53 the data in the relationship of a reference source and a reference destination within the release target region closed region 55a, or moves the referenced data (survived data) referenced from the referencing data (origin data) stored in the closed region 55b to the closed region 55b that stores the referencing data. After the movements, only garbage data is left in the closed region 55a.

The state [G] is a state in which the survived data has been moved to the region that stores the referencing data. In this example, the survived data is shown to have been moved to another closed region 55b and to the closing region 53. Thereafter, in S617, the region release section 266 changes the reference address for the referencing data to reference the referenced data to the region of the referencing data. In S619, as shown in the state [H], the region release section 266 releases the allocations of the closed region 55a that is the release target region, thereby collecting the memory area.

As explained above, the computer of the second embodiment selects the closed region where there exists numerous garbage data as the release target, thereby providing the effect of reducing the time spent examining reference relationship between data and of implementing efficient reuse of the memory.

### Third Embodiment

The computer of the second embodiment adopts the technique of getting the release target region determination section 265 to manage the updates that occurred to the data stored in the closed regions 55 as data change counts and to select, based on these data change counts, the closed region that is highly likely to contain garbage data as the release target.

One feature of the computer as the third embodiment is that it utilizes the data change counts to predict closed regions 55 that are likely to become the release target in the future and examines beforehand references to the data stored in the predicted closed regions 55. Part of the reference examination is carried out in advance to shorten the time for reference examination necessary at the time of the region release process.

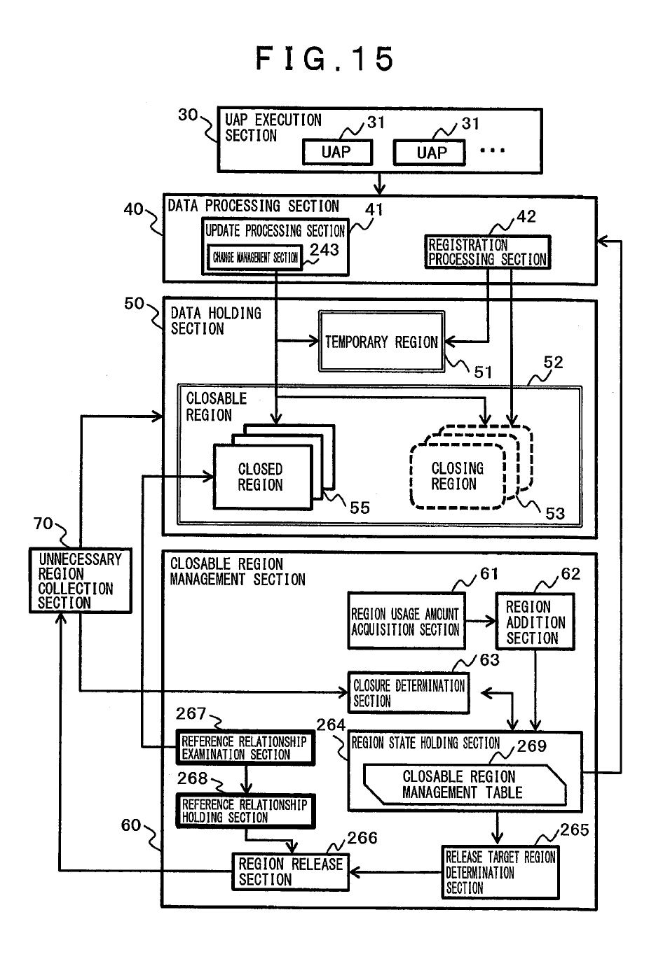

FIG. 15 shows structures of the functional sections configured in the memory 11 of the computer as the third embodiment. The computer of the third embodiment is configured to further include a reference relationship examination section 267 and a reference relationship holding section 268 in the closable region management section 60.

The reference relationship examination section 267 is a functional section that examines the data having references to the data stored in a “planned-to-be-released closed region” predicted to become a “release target region” from among the closed regions 55 based on the data change counts 289 (see FIG. 11) managed by the closable region management table 269.

The reference relationship holding section 268 is a functional section that stores the position information about the data acting as the reference sources referencing the data stored in the “planned-to-be-released closed region” on the basis of the result of reference examination performed by the reference relationship examination section 267.

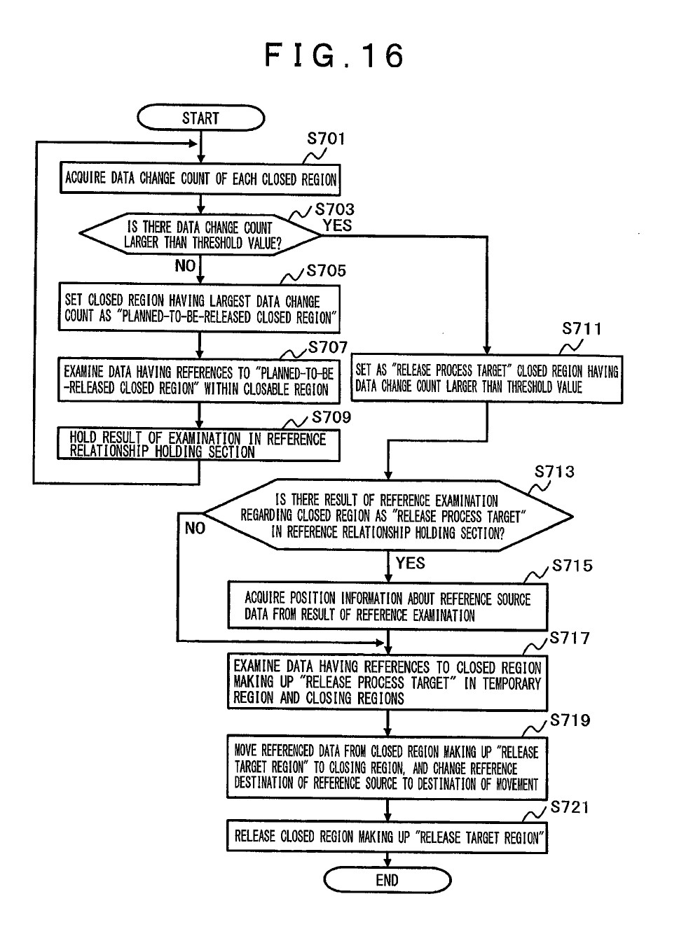

Using the flowchart of FIG. 16, the flows of a “preliminary process (from S701 to S709)” performed prior to a memory area release process and a “release process (from S711 to S721)” carried out on the memory are explained.

In S701, the release target region determination section 265 acquires the data change count 289 of each closed region 55 from the closable region management table 269. This acquisition process may be carried out in synchronism with each data change or in an asynchronous manner.

In S703, the release target region determination section 265 determines whether there exists any closed region 55 having a data change count larger than a threshold value from among the acquired data change counts 289. If it is determined that such a closed region 55 exists (S703: Yes), the release target region determination section 265 goes to the process of S711. On the other hand, if it is determined that there is no such closed region 55 (S703: No), the release target region determination section 265 goes to the process of S705.

In S705, the release target region determination section 265 sets the closed region 55 having the largest data change count as the “planned-to-be-released closed region” and notifies the reference relationship examination section 267 thereof.

In S707, the reference relationship examination section 267, notified of the “planned-to-be-released closed region,” examines the data having references to the data which exists in a closed region 55 and which is stored in the “planned-to-be-released closed region” from among the data stored in the closed regions 55.

In S709, the reference relationship examination section 267 transmits the position information about the data examined in the process of S707 to the reference relationship holding section for storage therein.

Thereafter, the reference relationship examination section 267 returns to the process of S701.

S711 through S721 constitute the flow of the process of releasing the closed region 55. One feature of this process is that primarily the region release section 266 utilizes the position information held in the reference relationship holding section 268 about the data having references to the data stored in the “planned-to-be-released closed region.”

In S711, the release target region determination section 265 sets as the “release target region” the closed region 55 of which the data change count is larger than the threshold value, and notifies the region release section 266 thereof.

In S713, the region release section 266 verifies whether the reference examination holding section 268 holds the position information about the data that references the data stored in the closed region 55 set as the “release target region.” If it is determined that the position information is held in the reference examination holding section 268 (S713: Yes), the region release section 266 goes to step S715. The region release section 266 then acquires the position information held in the reference examination holding section 268, before going to S717.

On the other hand, if it is determined that the position information is not held in the reference examination holding section 268 (S713: No), the region release section 266 goes to step S717.

In S717, the region release section 266 examines the temporary region 51 and closing regions 53 for the position information about the data having references to the data stored in the closed region 55 set as the “release target region.” If there exists such data, the region release section 266 acquires the position information about the data.

In S719, based on the position information about the data examined in S717 and found in the temporary region 51 and closing regions 53 and on the position information acquired in S715 and held in the reference examination holding section 268, the region release section 266 moves the data stored in the closed region 55 set as the “release target region” to a closable region 52 other than the closed region 55 that is the release target region, and changes the position information about the referenced data for the referencing data to the closable region 52 that is the destination of the movement.

In S721, the region release section 266 releases the memory allocations to the closed region 55 set as the “release target region,” thereby releasing (collecting) the region.

As explained above, the computer of the third embodiment examines the closed regions 55 for references through the “preliminary process” so as to retain as needed the position information about reference data in advance of the region release process. This makes it possible, when the region release process is started, to limit to the temporary region 51 and closing regions 53 the range of examining reference sources regarding the data present in the closed region 55 that is the release target region. This provides the effect of reducing the UAP downtime necessary for the reference source examination in the region release process.

### Fourth Embodiment

One of the major features of the computer as the fourth embodiment is that when the survived data and other data stored in the closed region 55 making up the release target are to be moved to another closable region 52, the computer selects as the movement destination a closed region 55 that is not likely to become the “release target region” in the future. More specifically, a region as the movement destination having a small data change count is selected using the data change count regarding each of the closing regions 53 and closed regions 55 in the closable region 52. This lowers the number of data that need to be moved from the closed region 55 targeted for release during the region release process in the future, thereby reducing the time required for the release process.

The fourth embodiment is configured so that as with the computers of the second and the third embodiments (see FIGS. 10 and 15), the change management section 243 detects updates in the closed regions 55 and holds the data change count 289 (see FIG. 11) representing the number of updates in the closable region management table 269.

Also, the fourth embodiment is configured so that the region release section 266 (FIGS. 10 and 15) examines the referencing data referencing the data stored in the closed region 55 constituting the release target region and that, when survived data and other data are to be moved from the closed region 55 making up the release target based on the result of the reference examination, one of a plurality of closed regions 52 with the smallest data change count is selected as the movement destination to which the survived data and other data are moved.

The flow is explained below in which the closed region 55 that will become the release target region is predicted periodically and in which the reference source examination inside the closed region is performed in advance of the release process.

The closed region with no result of the reference source examination and having the largest data change count 289 (i.e., update count) is acquired from the region state management table 269. And it is examined whether there exist references from the closed regions other than the closed region acquired above to the data contained in the acquired closed region, and the result of the examination is retained as the reference source examination result.

If a closing region has been changed to a closed region, the information about references from the data contained in that closed region will not be included in the reference source examination result. And once the process of releasing the closed region is completed, the data contained in the closed region that no longer exists as a result of the release process will be included in the reference source examination result. Such fluctuations in the number of closed regions turn the existing reference source examination result into obsolete information that does not indicate the changed status. Thus whenever a closed region is added or removed, the reference source examination result is discarded and the reference source examination is carried out anew. Alternatively, the reference source examination result may be updated even as the old result is retained. In this case, the reference source examination result in effect when a closed region is added or removed is marked as the old information. When the reference source examination result marked as the old information is to be used, the IDs indicative of the closed regions in effect at the time of the old information examination are retained and compared with the current IDs so as to identify the closed region that is added or removed. And references are examined from the data contained in the closed region identified by the comparison to the closed region on which the reference source examination involving the old information was carried out. This updating work may be performed when the release process is carried out.

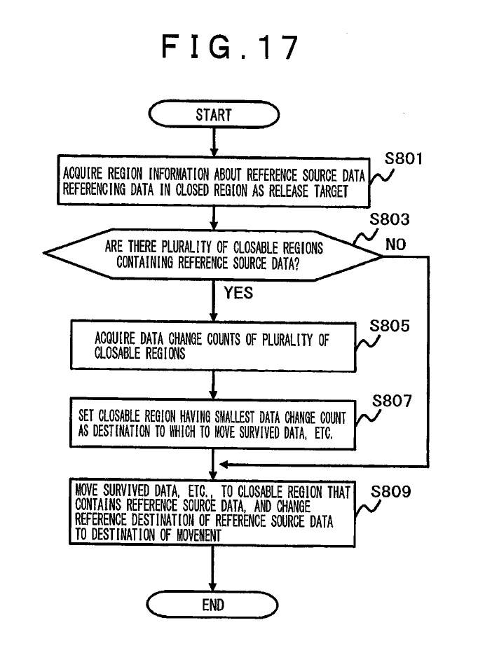

The flow of a “data movement destination determination process” performed by the computer of the fourth embodiment is explained below using the flowchart of FIG. 17. It is assumed that the region release section 266 has carried out the reference source examination on the data stored in the closed region 55 constituting the release target (S607 (FIG. 13) of the second embodiment) and 5717 (FIG. 16) of the third embodiment).

In S801, the region release section 266 acquires from the reference source examination result the information about the closable region 52 to which belongs the referencing data referencing the data inside the closed region 55 making up the release target.

In S803, the region release section 266 determines whether there exists a plurality of regions in the acquired closable region 52. If it is determined that a plurality of regions exist (S803: Yes), the region release section 266 goes to the process of S805. On the other hand, if it is determined that there is only one region (S803: No), the region release section 266 goes to the process of S809.

In S805, the region release section 266 acquires the data change count 289 from the closable region management table 269 with regard to each of these multiple regions present in the closable region 52.

In S807, the region release section 266 selects the region having the smallest data change count acquired, and sets the selected region as the destination to which to move the survived data and other data from the closed region 55 constituting the “release target region.” That is, the region unlikely to become the “release target region” in the future is set as the destination to which the survived data and other data are moved.

In S809, the region release section 266 moves the survived data and other data of the movement target to the region set as the movement destination and changes the information possessed by all referencing data concerning the references to the moved data, to the position information about the movement destination.

With the above-described processing, it is possible to move the referenced data making up the movement target in the closed region 55 as the “release target region” to the region in the closable region 52 that is unlikely to become the target for the release process. The “data movement destination determination process” reduces the possibility that the survived data and other data once moved will again become the target for movement, thereby lowering the number of times the movement process is performed. This provides the effect of reducing the UAP downtime attributable to the movement process.

### Fifth Embodiment

The first through the fourth embodiment have been explained so far. Lastly, the computer of the fifth embodiment is explained.

One of the features of the computer as the fifth embodiment is that it includes a service level management device for causing the above-described diverse processes to be carried out in keeping with a service level in coordination with the computers of the first through the fourth embodiments.

The service level refers to the length of time that elapses from the time a client transmits a request to the UAP 31 to the time the client receives a response to that request. With this embodiment, the service level is a threshold value of the total time made up of a network communication time required for the client to transmit a request to the UAP 31 from a client and to receive a response therefrom, a processing time required for the UAP 31 to process the request, and a UAP processing downtime due to the region release process.

The service level management device is capable of acquiring these times and displaying them on a display device, and has the function of dynamically detecting a divergence that may occur between the service level threshold value and the actual service and causing the computer to change its various processing times in reference to the service level threshold value. The service level management device also has the function of changing these processing times based on the settings furnished by a user.

The “region release process” performed by the closable region management section 60 is explained here as an example of the process of the computer targeted for changing such processing times with this embodiment. When selecting the closed region 55 as the release target, the computer of any of the second through the fourth embodiments utilizes the data change count 289 indicative of the number of times updates have occurred to the data contained in that closed region 55. If the data change count 289 becomes larger than the predetermined threshold value, the release target region determination section 265 of the closable region management section 60 selects the corresponding closed region 55 as the release target region (e.g., in S603 of the second embodiment; see FIG. 13).

Before releasing the selected closed region 55, the closable region management section 60 moves the necessary data held in that closed region (reference destination data) to another closing region 53 or the like in the closable region 52. If the data change count 289 is large, the amount of the data to be moved is increased. On the other hand, if the data change count 289 is small, the amount of the data to be moved is reduced. Since the processing of the UAP 31 is halted during the data movement process, the number of the data to be moved is a factor directly related to the service level.

Thus the processing downtime of the UAP 31 is made changeable when the service level management device changes the threshold value of the data change count 289, whereby the service level can be adjusted.

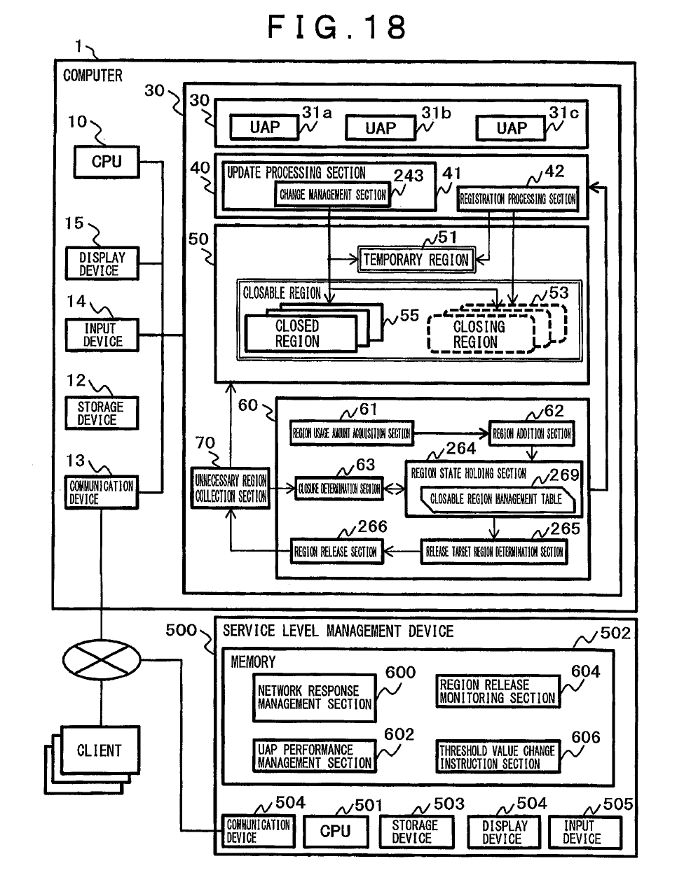

FIG. 18 shows a configuration of the computer as the fifth embodiment. In FIG. 18, a service level management device 500 made of a general-purpose server is configured to communicate with the computer and clients via a network. Alternatively, the service level management device 500 may be configured as a software functional section inside the computer. As another alternative, the service level management device 500 may be configured as a software functional section on the clients. Also, FIG. 16 shows an example in which the service level management device 500 is added to the computer serving as the basis and having the functional structure of the second embodiment (see FIG. 10). Obviously, the computer of the third or the fourth embodiment may also be utilized.

In a memory 502 of the service level management device 500, there are implemented various functional sections including a network response management section 600, a UAP performance management section 602, a region release monitoring section 604, and a threshold value change instruction section 606 in coordination with programs.

The network response management section 600 is a functional section that acquires a network processing time required for a client to transmit a request to a UAP 31a or the like and for the UAP 31a or the like to return a response to the request. With this embodiment, the network response management section 600 acquires the network processing time by querying the clients.

The UAP performance management section 602 is a functional section that acquires the time required for the UAP 31a or the like to process a request. The UAP performance management section 602 acquires the processing time by querying the UAP 31a or the like.

The region release monitoring section 604 is a functional section that monitors the time during which the UAP 31a or the like halts its processing due to the “region release process” performed by the closable region management section 60, calculates the actual service time, and calculates the number of necessary data that can be moved from the closed region 55 making up the release target during the “region release process.” Also, the region release monitoring section 604 has the function of monitoring the divergence between the actual service time and the service level and calculating the threshold value against which the release target region determination section 265 during the “region release process” determines the number of service changes if the actual service time exceeds the service level or falls short thereof.

The threshold value change instruction section 606 is a functional section that receives notification of the threshold value for determining the service change count calculated by the region release monitoring section 604 and gives the release region determination section 265 instructions to change the threshold value of the data change count.

A display device 504 displays the screen which shows diverse information acquired by the service level management device 500 and through which the user performs input by means of an input device 505.

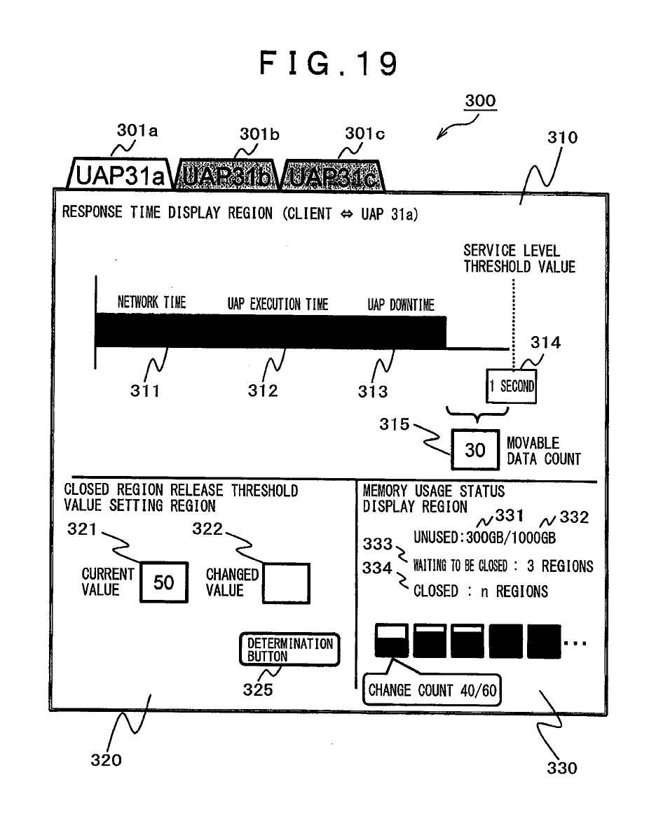

FIG. 19 schematically shows a screen 300 displayed on the display device 503. The screen 300 is displayed for each UAP 31. When the user presses or otherwise operates each of tags 301a, 301b and 301c on the screen using the input device 505 such as a mouse, the screen can be switched to the information about each UAP 31 (FIG. 17 shows an example of display concerning the UAP 31a).

A response time display region 310 displays using line segments a network time 311 as the communication time between the client and the UAP 31a, a UAP execution time 312 required for the processing of the UAP 31a, and a UAP downtime 313 as the time in which the processing of the UAP 31a is halted for the “region release process.” Furthermore, the response time display region 310 displays a service level threshold value 315 (“1 second” in the drawing), and a movable data count 315 indicative of the number of data that can be moved from the release target region during the time difference between the service level threshold value 315 on the one hand and the current response time (the sum of the network time 311, UAP execution time 312 and UAP downtime 313) on the other hand (the drawing shows 30 data can be moved, for example).

Incidentally, the service level threshold value 314 is an initially set value or a value input by the user beforehand. Alternatively, the service level threshold value 314 may be set by input from the user.

The region release monitoring section 604 can calculate the movable data count 315 by multiplying the time difference between the service level threshold value 314 and the response time by a predetermined time required to move one data item.

A closed region release threshold value setting region 320 displays a current value 321 (“50”) of the data change count 289 constituting the release threshold value of the closed region 55, a changed value input field 322 that admits input of a changed value of the threshold value in question, and a determination button 325.

The service level management device 500 allows the region release monitoring section 604 to dynamically monitor the difference between the actual service time and the service level and causes the release target region determination section 265 to change the threshold value of the data change count. The threshold value can also be set in accordance with the user's instructions. In this case, the user compares the current value 321 with the movable data count 315, inputs a desired threshold value to the changed value 322, and operates the determination button 325, thereby adjusting the actual service time.

A memory usage status display region 330 displays an unused memory region size 331 (“300 GB”), a maximum available memory size 332 (“1000 GB”), a current closing region count 333 (“3 regions”), and a current closed region count 334 (“n regions (n=integer)”). The memory usage status display region 330 further displays schematically the usage status of the current closing regions 53a, 53b and 53c, of the closed regions 55a through 55n and of other regions.

When one of schematically displayed pictorial figures is selected, the corresponding usage status is expressed numerically. For example, if the total number of data registered in the closed region 55a is 60 and the number of data having undergone such changes as updates or deletion therein is 40, the status is expressed as 40/60 where the total data count is the denominator and the change count is the numerator.

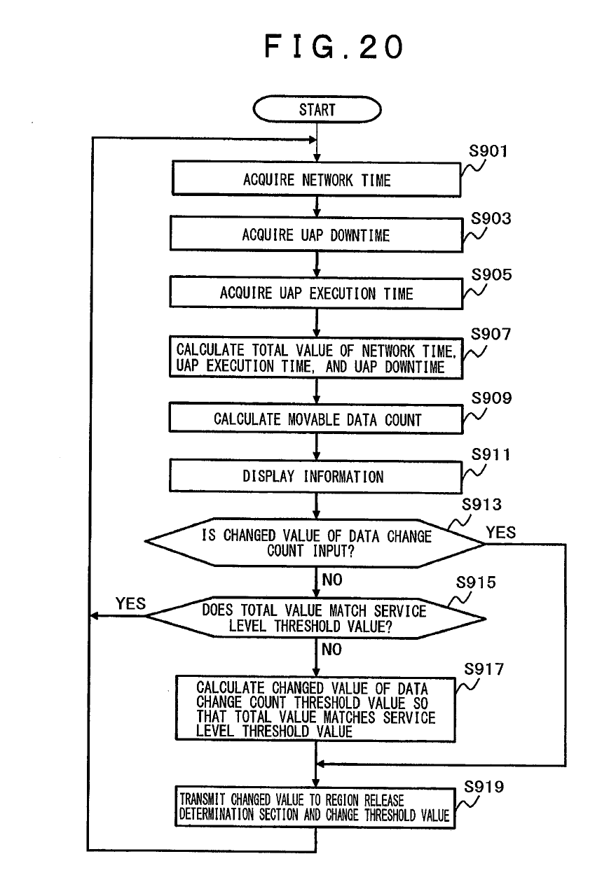

The flow of the processing by the service level management device 500 is explained below using the flowchart of FIG. 20. Although the processing hereunder is carried out by various functional sections of the service level management device 500, the service level management device 500 is presented as the subject of the processing for purpose of simplification and illustration.

In S901, the service level management device 500 communicates with the client and acquires periodically the network time 311 required for the communication between the client and the computer.

In S903, the service level management device 500 acquires from the closable region management section 60 a closable region management log including the time in which the UAP is halted to manage the closable region 52, thereby obtaining the UAP downtime 313.

In S905, the service level management device 500 acquires the UAP execution time 312 from the UAP 31 or the like.

In S907, the service level management device 500 calculates periodically the total value of the acquired network time 311, UAP execution time 312, and UAP downtime 313.

In S909, the service level management device 500 calculates the movable data count 315 based on the difference between the service level threshold value 314 and the total value (response time) calculated in S907 and on the time required to move one data item.

In S911, the service level management device 500 displays the information acquired in the process of S901 through S909 and various information stored in advance as shown on the screen 300 in FIG. 19.

In S913, the service level management device determines whether the changed value 322 of the threshold value for the data change count 289 is input via the closed region 320 on the screen 300. If it is determined that there is no input of the changed value 322 of the data change count threshold value from the user (S913: No), the service level management device goes to the process of S915. If it is determined that there is a changed input (S913: Yes), the service level management device goes to the process of S919.

In S915, the service level management device 500 determines whether the total value calculated in S907 matches the service level threshold value 314. If it is determined that there is a mismatch (S915: No) (the total value exceeding or falling short of the threshold value), the service level management device 500 goes to S917. If it is determined that there is a match (S915: No), the service level management device 500 returns to the process of S901.

In S917, the service level management device 500 calculates the changed value of the data change count threshold value in such a manner that the total value matches the service level threshold value 314. Specifically, if the total value is smaller than or equal to the service level threshold value 314, the changed value is obtained by adding the movable data count 315 to the current value 321. Conversely, if the total value exceeds the service level threshold value 314, the changed value is obtained by subtracting the movable data count 315 from the current value 321.

In S919, the service level management device 500 transmits to the release target region determination section 265 the changed value of the data change count threshold value obtained in S913 or S917, thereby changing the threshold value.

In this manner, the computer of the fifth embodiment can dynamically or statically keep the service level constant and allow the user to adjust the actual service response time as desired.

As explained above, the present invention can be applied to the diverse embodiments discussed so far. However, the present invention is not limited to these embodiments and can be changed diversely in design within the spirit and scope thereof. For example, the above-described embodiments are explained in detail so that this invention may be well understood and are not necessarily limited to their entire structures. Also, part of the structure of one embodiment may be replaced with a structure of another embodiment, and the structure of one embodiment may be additionally provided with a structure of another embodiment.

Furthermore, the above-described structures, functions, processing sections, processing means, etc., may be implemented in part or in total using hardware of suitably designed integrated circuits or the like, or using software of programs interpreted and executed by processors to bring about the relevant functions. The programs, tables, files, and other information for implementing the functions may be held on recording media such as memories, hard disks, SSDs (Solid State Drives), IC cards, SD cards, or DVDs. Obviously, such information can be downloaded via communication lines such as the Internet.

Also, only those control lines and information lines that are deemed necessary for explanation purposes have been indicated. Not all control lines and information lines have been shown. Almost all structures may also be considered to be interconnected.

### REFERENCE SIGNS LIST

30 UAP execution section
31 UAP
40 Data processing section
41 Update processing section
50 Data holding section
51 Temporary region
52 Closable region
53 Closing region
55 Closed region
60 Closable region management section
64 Region state holding section
69 Closable region management table
70 Unnecessary region collection section
243 Change management section
265 Release target region determination section
266 Region release section
267 Reference relationship examination section
268 Reference relationship holding section
314 Service level threshold value
315 Movable data count
500 Service level management device

1. A computer having an arithmetic unit and a memory for carrying out a predetermined business application, the computer comprising:
memory management means for managing the memory while dividing the memory into at least a first storage area which stores generated data, and a closable region made of at least one second storage area and at least one third storage area, the second storage area constituting a destination to which the data stored in the first storage area is to be moved, the third storage area not constituting a destination to which the data stored in the first storage area and the second storage area is to be moved;
data movement means for moving data having relations to the data in the first storage area to the second storage area;
area change means for changing the second storage area to which the data has been moved to the third storage area;
update detection means for detecting an update to the data stored in the third storage area;
updated data movement means for moving the data of which the update has been detected to a closing region in the second storage area; and
examination means for examining the relations in the memory between the data in the closing region to which the data has been moved and the data stored in the first storage area.

2. The computer according to claim 1, wherein, if an amount of stored data exceeds a predetermined threshold value, the area change means changes the second storage area to the third storage area.

3. The computer according to claim 1, wherein the update detection means further manages the number of times the data stored in the closable region has been updated for each of the closable regions, and, of the data stored in the third storage area of which the number of times is larger than a predetermined threshold value, the data referenced from the data stored in the first storage area, the second storage area, and the third storage area other than the third storage area of which the number of times is larger than the predetermined threshold value is moved as survived data to a closable region.

4. The computer according to claim 2, further comprising extraction means for extracting the third storage area of which the number of times is the largest but smaller than the predetermined threshold value,
wherein the updated data movement means moves the data stored in the third storage area extracted by the extraction means to a closable region other than the third storage area and the closable region of which the number of times is larger than the threshold value.

5. The computer according to claim 1, wherein, when moving the data stored in the third storage area, the updated data movement means moves the data of interest to an area inside the closable region which stores the data having relations to the data of interest inside the closable region.

6. The computer according to claim 4, wherein, when moving the data from the third storage area, the updated data movement means moves the data to the closable region of which the number of times is the smallest.

7. The computer according to claim 1, further comprising region release means for releasing the third storage area after the updated data movement means has moved the data stored in the third storage area.

8. The computer according to claim 1, wherein the relations of the data are reference relationship of object data.

9. The computer according to claim 3, further comprising:
an interface for allowing a request from a client with regard to the business application and a result thereof to be transmitted and received via a network; and
management means for managing the request and the result of the processing thereof,
wherein the management means monitors processing performance provided by the business application based on the request and the result and, in accordance with the processing performance, causes the threshold value of the number of times to be changed.

10. The computer according to claim 9, wherein the management means receives input of a service level constituting a threshold value of a processing time required from the time the client transmits a request from a user to the time a result of the processing thereof is received and, in accordance with the time difference between the service level in question and an actually measured time of actual processing, causes the threshold value of the number of times to be changed.

11. The computer according to claim 10, wherein the management means causes at least a display device to display the service level, the actually measured time and the threshold value of the current number of times.

12. A management method for a computer having an arithmetic unit and a memory for carrying out a predetermined business application, the management method comprising:
a memory managing step of causing the computer to manage the memory while dividing the memory into at least a first storage area which stores generated data, and a closable region made of at least one second storage area and at least one third storage area, the second storage area constituting a destination to which the data stored in the first storage area is to be moved, the third storage area not constituting a destination to which the data stored in the first storage area and the second storage area is to be moved;
a data moving step of causing the computer to move data having relations to the data in the first storage area to the second storage area;
an area changing step of causing the computer to change the second storage area to which the data has been moved to the third storage area;
an update detecting step of causing the computer to detect an update to the data stored in the third storage area;
an updated data moving step of causing the computer to move the data of which the update has been detected to a closable region other than the third storage area; and
an examining step of causing the computer to examine relations in the memory between the data in the closable region to which the data has been moved and the data stored in the first storage area.

13. The management method according to claim 12, wherein, if an amount of stored data exceeds a predetermined threshold value, the area changing step causes the computer to change the second storage area to the third storage area.

14. The management method according to claim 12,
wherein the update detecting step causes the computer to further manage the number of times the data stored in the closable region has been updated for each of the closable regions, and
the updated data moving step causes the computer to move the updated data stored in the third storage area of which the number of times is larger than a predetermined threshold value to a closable region other than the third storage area.

15. The management method according to claim 13, further comprising an extracting step of causing the computer to extract the third storage area of which the number of times is the largest but smaller than the predetermined threshold value,
wherein the updated data moving step causes the computer to move the data stored in the third storage area extracted in the extracting step to a closable region other than the third storage area and the closable region of which the number of times is larger than the threshold value.

16. The management method according to claim 12, wherein, when moving the data stored in the third storage area, the updated data moving step causes the computer to move the data of interest to an area inside the closable region which stores data having relations to the data of interest inside the closable region.

17. The management method according to claim 12, wherein, when moving the data from the third storage area, the updated data moving step causes the computer to move the data to the closable region of which the number of times is the smallest.

18. The management method according to claim 12, further comprising an area releasing step of causing the computer to release the third storage area after the computer is caused to move the data stored in the third storage area.

19. The management method according to claim 14,
wherein the computer further includes an interface for allowing a request from a client with regard to the business application and a result thereof to be transmitted and received via a network, and
a management section which manages the request and the result of the processing thereof, the management method further comprising the step of causing the management section to monitor the processing performance provided by the business application based on the request and the result and, in accordance with the processing performance, to change the threshold value of the number of times.

20. A non-temporary recording medium for storing a program to be executed by a computer having an arithmetic unit and a memory, the program comprising:
a memory managing step of managing the memory while dividing the memory into at least a first storage area which stores generated data, and a closable region made of at least one second storage area and at least one third storage area, the second storage area constituting a destination to which the data stored in the first storage area is to be moved, the third storage area not constituting a destination to which the data stored in the first storage area and the second storage area is to be moved;
a data moving step of moving the data having relations to the data in the first storage area to the second storage area;
an area changing step of changing the second storage area to which the data has been moved to the third storage area;
an update detecting step of detecting an update to the data stored in the third storage area;
an updated data moving step of moving the data of which the update has been detected to a closable region other than the third storage area; and
an examining step of examining relations in the memory between the data in the closable region to which the data has been moved and the data stored in the first storage area.
